(19) United States
(12) Patent Application Publication
(10) Pub. No.: US 2018/0214258 A1
(43) Pub. Date: Aug. 2, 2018

(54) PACKAGE FOR ORTHODONTIC BRACKETS

(71) Applicant: DENTSPLY SIRONA Inc., York, PA (US)

(72) Inventors: Tieming RUAN, Setauket, NY (US); Calvin NG, Hollis, NY (US); Sivaramakrishnan KRISHNAMOORTHY, Albertson, NY (US)

(73) Assignee: DENTSPLY SIRONA Inc., York, PA (US)

(21) Appl. No.: 15/746,025

(22) PCT Filed: Jul. 24, 2015
(86) PCT No.: PCT/US2015/041902

§ 371 Date: Jan. 19, 2018

(51) Int. Cl. A61C 19/02; A61C 7/14

(52) U.S. Cl. CPC A61C 19/02; A61C 2202/01; A61C 7/14

(57) ABSTRACT

A package (10, 10′) for securing an orthodontic bracket (30) includes a pocket (12, 71) having an inclined floor (40, 70) and a mechanical locking device (51, 71) for removably holding the bracket (30) in the pocket (12, 71) until it is intentionally removed by a user.

### FIELD OF THE DISCLOSURE

The present disclosure is directed toward packaging for dental devices. More particularly, the disclosure is directed toward packaging for orthodontic brackets.

### BACKGROUND OF THE DISCLOSURE

In orthodontic procedures, a bracket is a device that is affixed to the dentition for the purpose of being used (often with a wire) to exert a controlled force upon a tooth for sufficient time to cause the tooth to move in a desired direction according to a prescribed treatment plan. It is common in orthodontic procedures to use a series of brackets having different structures depending upon the stage of the patient's treatment plan, the tooth to which the bracket is affixed, the type and location of the wires and the like. Each tooth or several teeth of a patient may receive a bracket having a different shape, size or function from that of any adjacent teeth. It is helpful for the dental professional to receive sets of such different brackets organized in a manner to facilitate the proper and efficacious placement of each bracket. It has been common in the industry to affix such sets of orthodontic brackets in order corresponding to the patient's dentition, either in a small container having individual pockets or cups to hold a given bracket or by adhesively bonding the bracket in such a pocket or on a card or the like, such as by using an adhesive or a stick tape.

With previous containers having pockets that do not secure a bracket in an individual pocket, it is often the case that the brackets are jumbled in shipment, or worse yet, spill out of the pocket when the package is opened. Adhesively bonding the bracket in a pocket or to a card is not desirable because residual adhesive left on the bracket could negatively affect the bonding of the bracket to the patient's tooth.

A need exists therefore, for a package for storing, shipping and facilitating placement of a plurality of orthodontic brackets. The package should prevent an individual bracket from undue movement out of position until the bracket is intentionally removed from the package by a user. It would be beneficial if such a package secured the brackets without requiring the use of an adhesive, a stick tape of the like.

### SUMMARY OF THE DISCLOSURE

A package for at least one orthodontic bracket has a base with at least one open pocket. The pocket has an inclined floor and a mechanical holding means for removably fixing the orthodontic bracket in the pocket. In one embodiment of the invention, the mechanical holding means includes a pair of spaced apart positioning tabs that physically engage the bracket there between such as by a friction fit or opposing gripping faces. The tabs may be resilient such that they physically impinge the bracket between them until the user intentionally removes the bracket from the pocket.

In an alternative embodiment of the invention, the pocket as above is further provided with a resilient material that deforms to receive and resiliently hold the bracket in the pocket. In this embodiment, the pocket may be provided with resilient foam such as a foam rubber, polystyrene, polyurethane, rubber, plastic or other resilient material, even paper or the like. The bracket is thereby held within the pocket until intentionally removed by the user.

### BRIEF DESCRIPTION OF THE DRAWINGS

FIG. 1 is a front, perspective view of a package according to the present invention.

FIG. 2 is a perspective view of a cover for the package of FIG. 1.

FIG. 3 is a close up, front perspective view of one portion of the package of FIG. 1, being a pocket according to the invention and showing an orthodontic bracket positioned therein according to the invention.

FIG. 4 is a front, perspective view of an alternative embodiment of a package according to the present invention.

FIG. 5 is a perspective view of a cover for the package of FIG. 4.

FIG. 6 is a close up, top view of one portion of the package of FIG. 4, being a pocket according to the invention and showing an orthodontic bracket positioned therein according to the invention.

FIG. 7 is a side elevational, section view of the package of FIG. 4.

FIG. 8 is a side elevational view of a portion of the package of FIG. 7.

FIG. 9 is a bottom plan view of one portion of the package of FIG. 4.

FIG. 10 is a top plan view of an alternative embodiment of the portion of the pocket shown in FIG. 6.

### DETAILED DESCRIPTION OF THE DISCLOSURE

The present disclosure now will be described more fully hereinafter with reference to the accompanying drawings, in which exemplary embodiments of the disclosure are shown. This disclosure may, however, be embodied in many different forms and should not be construed as limited to the embodiments set forth herein.

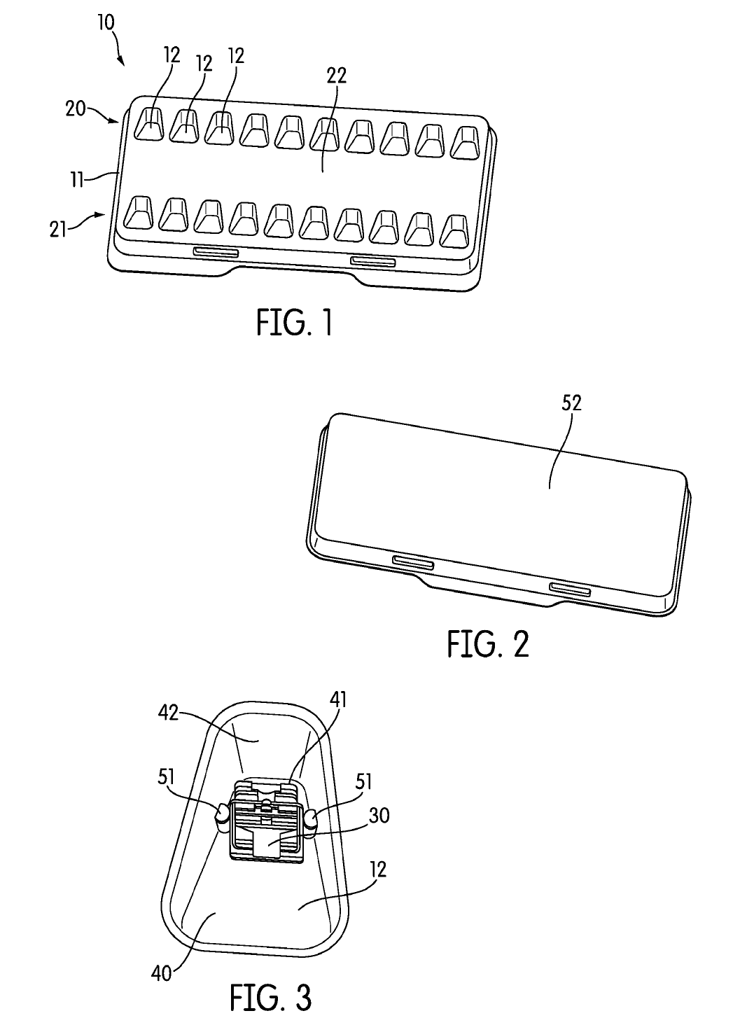

A package according to the present invention is shown by way of example by the number 10 on the attached drawings. Package 10 includes a base 11 and a plurality of wells or pockets 12 in base 11. As shown in FIG. 1, there are preferably two rows of pockets 12, row 20 and row 21, corresponding in turn to the upper and lower arch of a patient (not shown). Row 20 and 21 may be spaced apart by a top portion 22 of base 11. Top portion 22 may be used for example to carry indicia (not shown) corresponding to a treatment procedure.

It will be appreciated that a series of brackets such as bracket 30 (FIG. 3) can be individually placed in pockets 12 in a prescribed sequence, such as that corresponding to a patient's dentition, the order of use or the like.

Each pocket 12 is provided with an inclined floor 40. By “inclined” it is meant that floor 40 is tilted with respect to top portion 22 or the like. By such an inclined positioning, a bracket 30 placed within a pocket 12 will be induced by gravity toward the lower end of the inclined floor, depicted by the number 41 on the drawings. A back wall 42 is preferably provided to at least partially surround the lower end 41 of the pocket 12, thereby further holding the bracket 30 therein.

It is also preferred to provide each pocket 12 with a mechanical holding means or device to physically engage the bracket 30 in the pocket 12, thereby further securing the bracket 30 in the pocket 12. By “mechanical holding means or device” it is meant a structure that holds the bracket, preferably in a removable manner, by physical contact, without the need for an adhesive. By way of example, pins 51 may be provided in pocket 12 such that separate pins 51 are in a spaced arrangement such that the bracket 30 may be placed between them. By preferably being spaced apart a distance slightly less than that of bracket 30, pins 51 physically engage and hold bracket 30 there between by friction or by resilient force. By forming pins 51 from a suitable material such as a plastic, elastomer or the like, pins 51 may slightly deform as bracket 30 is placed there between and then exert a resilient force toward each other, impinging upon and holding bracket 30 in place.

As shown in FIG. 2, a suitable cover or lid 52 may be provided to enclose base 11 and cover each pocket 12 until desired use. When it is desired to use a given bracket 30, cover 52 is removed and a bracket 30 is removed from a pocket 12 by use of a tweezers or other tool. By being open and having inclined floor 40, such removal is facilitated.

Package 10 and its components as described above may be formed by any suitable means and from any suitable material. Preferably package 10 is formed from a plastic, elastomeric or other polymeric material by injection molding, vacuum or other thermo-forming, milling or any other conventional method.

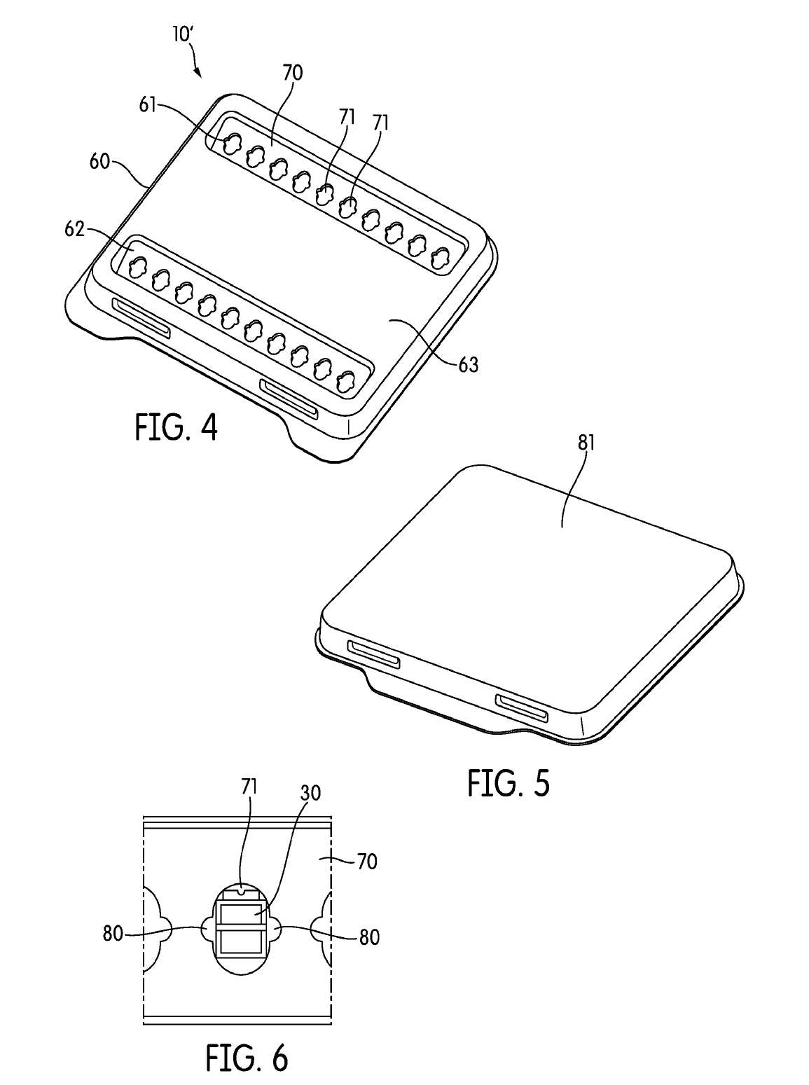

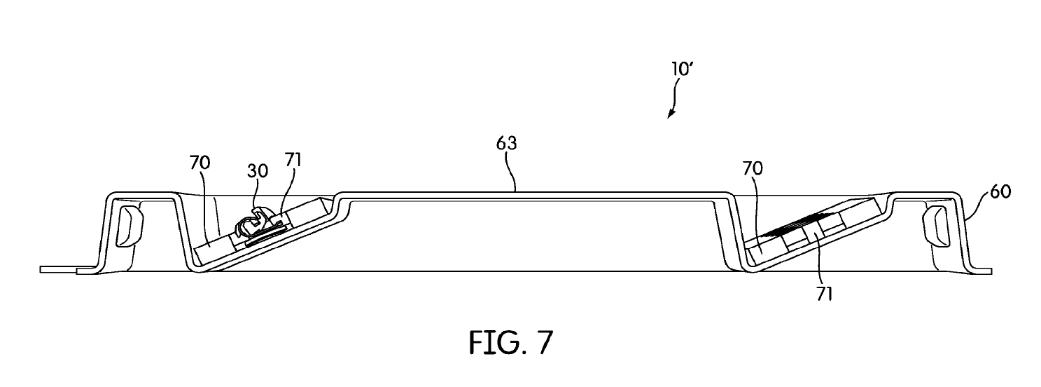

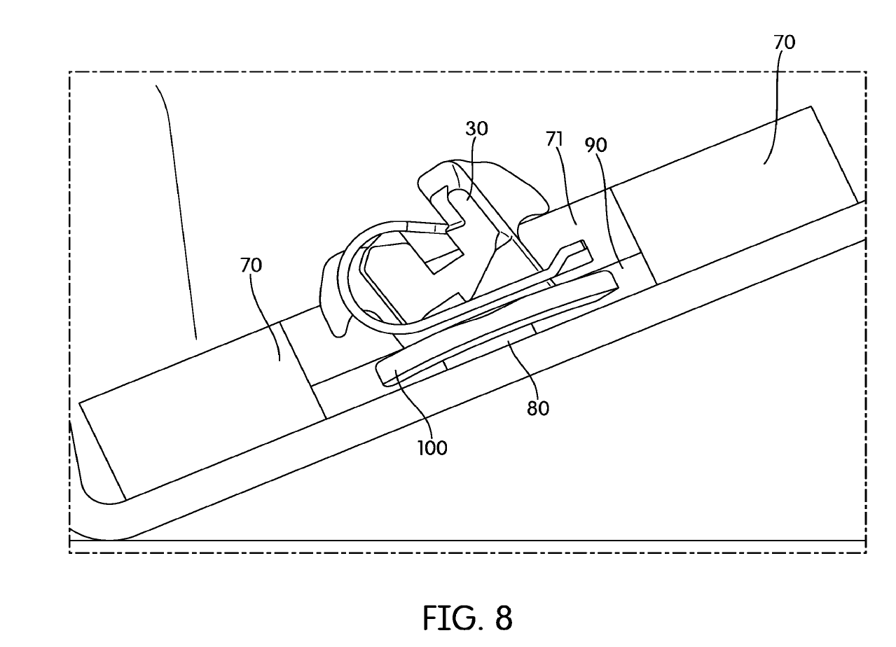

As shown in FIGS. 4 and 6, an alternative embodiment of a package according to the invention is shown by the number 10′, and includes a base 60 and a single well or pocket 61. Pocket 61 has an inclined floor 62 similar to floor 40 above described. In this embodiment, pocket 61 is elongate in shape and provided with a floor covering 70 having a plurality of individual and preferably regularly spaced bracket receiving apertures 71. Each aperture 71 is sized and configured to receive a bracket 30 and physically engage or touch bracket 30 to hold bracket 30 therein. Preferably floor covering 70 is made of a resilient material such as a foam rubber, polystyrene, polyurethane, paper, plastic or any other resilient material. Each aperture 71 is preferably sized and shaped to have at least one dimension that is slightly less than the outer dimension of at least a portion of a bracket 30 to be held therein, such that aperture 71 physically impinges upon or touches bracket 30 to hold bracket 30 therein. By being preferably formed from a resilient material, floor covering 70 and hence, apertures 71 can thus be slightly deformed when a bracket 30 is placed within an aperture 71, and then resiliently physically impinge upon bracket 30, securing it in place within aperture 71 until intentionally removed by a user. Such a configuration is an example of a mechanical locking device according to the present invention.

As with rows 20 and 21 of base 11 described above, base 60 may be provided with well 61 and a second well 62, each corresponding to an upper or lower arch of a patient. A flat area 63 may be provided to include indicia (not shown) as was similarly above described with respect to flat area 22. Further, although base 60 and floor covering 70 are shown and described as being separate materials, the structure could in fact be of a singular, monolithic manufacture, that is, made as a single piece and still have the characteristics as above described. It will additionally be appreciated that the shape, size and distribution of pockets 12, wells 61, 62 and apertures 71 may vary depending upon the desired end use and still fall within the scope of the present invention.

Each aperture 71 may also be provided with one or more cutouts 80. It will be appreciated that when it is desired to remove a bracket 30 from an aperture 71 wherein it is held, a tweezers or other tool (not shown) may be positioned in one or more cutouts 80 to engage and lift, pry or otherwise remove bracket 30 from the given aperture 71. The package 10′ may be provided with a lid 81 similar to lid 52 above described.

It is often encountered in the orthodontic market that a bracket 30 is packaged and shipped to the end user with a bonding adhesive affixed to the bracket 30, which adhesive will be used to bond to the patient's tooth (not shown). In this circumstance, package 10, 10′ and its associated lid 52, 81 may be made from an opaque material to restrict the transmission of light including UV light. This helps to prevent premature curing of the bonding material affixed to the bracket, especially when such material is cured by exposure to light. UV-cured bonding materials are common in the industry. In addition, a shield of material similar to lid 52, 81 could be provided that blocks the light that will cure the pre-pasted bonding material, but that allows the transmission of other light so that a user would still be able to view the contents of the package 10, 10′. For example, the lid or shield 52, 81 could be made of a material that blocks UV light but allows visible light to be transmitted through to allow such viewing. Although lids 52, 81 are depicted in the drawings as closure lids for packaging 10, 10′, the UV shield could just as well be a separate piece of material of any configuration placed within the package 10, 10′.

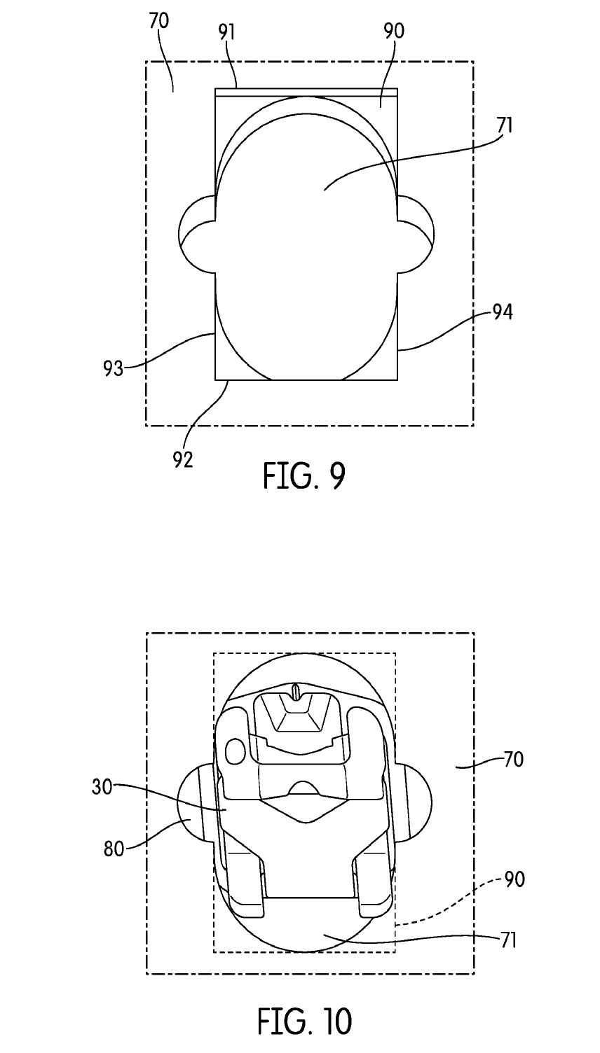

In a still further embodiment of the package 10′, floor covering 70 may be provided with an undercut 90 positioned generally juxtaposed to aperture 71. In FIG. 9, cutout 90 is shown as having top and bottom walls 91 and 92 respectively, and sidewalls 93 and 94 respectively. Although shown as being square, cutout 90 need not be of any particular shape as long as it meets the characteristics to now be described.

Cutout 90 is particularly suited for use with a bracket 30 having a base member 100 (FIG. 8) that is pre-pasted. By positioning bracket 30 having base member 100 in aperture 71 with cutout 90, bracket 30 is held in aperture 71 but the base member 100 is held at its edges only (FIG. 10). The pre-pasted bonding material (not shown) on base 100 would not be touched by a surface of package 10′, thereby maintaining the integrity of the bonding material during storage of bracket 30 within package 10′.

While only certain features and embodiments of the invention have been shown and described, many modifications and changes may occur to those skilled in the art (for example, variations in sizes, dimensions, structures, shapes and proportions of the various elements, mounting arrangements, use of materials, colors, orientations, etc.) without materially departing from the novel teachings and advantages of the subject matter recited in the claims. The order or sequence of any process or method steps may be varied or re-sequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

We claim:

1. A package for orthodontic brackets comprising:
a base; and
a pocket formed within the base and having an inclined floor, the pocket being arranged and disposed to exert a force that temporarily physically retains an orthodontic bracket in place within the pocket, wherein the package is sized and configured to retain at least two orthodontic brackets in a predetermined spatial relationship with respect to one another.

2. The package of claim 1, wherein the pocket is sized to receive and retain a single orthodontic bracket.

3. The package of claim 2, wherein the package comprises a plurality of pockets independently sized to receive and retain a single orthodontic bracket.

4. The package of claim 1, wherein the inclined floor of the pocket descends downwardly away from a top portion of the base.

5. The package of claim 1, wherein the pocket is an elongate well comprising a plurality of apertures within the pocket, each aperture independently sized to receive and retain a single orthodontic bracket.

6. The package of claim 1, wherein the pocket comprises a resilient material.

7. The package of claim 6, wherein the resilient material is elastomeric.

8. The package of claim 1, wherein the pocket is arranged and disposed to mechanically retain the bracket by impingement.

9. The package of claim 8, the pocket comprising a plurality of opposing tabs to impinge upon the bracket.

10. The package of claim 8, the pocket comprising an elastomeric material and having at least one aperture, the at least one aperture having at least one dimension less than a corresponding outer dimension of the bracket such that the aperture deforms upon insertion of the bracket and the elastomeric material thereafter impinges upon the bracket.

11. The package of claim 1, wherein the predetermined spatial arrangement is a sequence corresponding to a patient's dentition.

12. The package of claim 1 further comprising an orthodontic bracket contained within at least one of the pockets.

13. The package of claim 1, wherein the pocket comprises a pocket floor covering, the pocket floor covering comprising a resilient material.

14. The package of claim 1, further comprising a cover overlying the base.

15. The package of claim 14, wherein the cover is a UV light shield.

16. The package of claim 1, wherein the pocket is shaped to physically retain the orthodontic bracket by exerting the force at a plurality of locations about the bracket's perimeter.

17. The package of claim 16, wherein the pocket is shaped to physically retain the bracket by exerting the force about the perimeter of a base member of the orthodontic bracket.

18. The package of claim 16, wherein the pocket is shaped to have at least one cutout that deviates from the perimeter shape of the orthodontic bracket.

19. A package for orthodontic brackets comprising:
a base;
a plurality of pockets formed within the base and having an inclined floor that descends downwardly away from a top portion of the base;
a plurality of orthodontic brackets; and
mechanical holding means for temporarily retaining the plurality of orthodontic brackets within the plurality of pockets in a predetermined spatial relationship with respect to one another.
